(19) United States
(12) Patent Application Publication
(10) Pub. No.: US 2026/0233257 A1
(43) Pub. Date: Aug. 13, 2026

(54) SYSTEM OR MACHINE FOR SORTING OBJECTS WITH AN AERAULIC CONTROL DEVICE

(71) Applicant: PELLENC SELECTIVE TECHNOLOGIES, PERTUIS (FR)

(72) Inventors: Antoine BOURELY, LA TOUR D'AIGUES (FR); Julien CHERADAME, AIX EN PROVENCE (FR); David ESTEVE, PEYROLLES EN PROVENCE (FR)

(21) Appl. No.: 19/121,798

(22) PCT Filed: Oct. 16, 2023
(86) PCT No.: PCT/EP2023/078668

§ 371 Date: Apr. 20, 2026

(30) Foreign Application Priority Data
Oct. 17, 2022 (FR) 2210677

(51) Int. Cl. B07C 5/36

(52) U.S. Cl. CPC B07C 5/366; B07C 5/362; B07C 2501/0018

(57) ABSTRACT

The present invention relates to a system (1) for sorting objects (2) having, mounted in a casing (1′), a sorter (3) with a planar geometry and an aeraulic management system (4) controlling the circulation of air in the system (1). The system (1) includes an outlet box (10) from which the excess air is substantially discharged, by means of a suction operation, to the outside of the system without disturbing the flow of the unsorted or sorted objects (2). The system has two mutually independent air circulation devices (13, 14), for example with turbines, one (13) of which ensures the injection of external air for generating a laminar air flow (LAF) and the other (14) of which ensures the excess air at the outlet box (10) is discharged, by means of a suction operation, to the outside of the system (1). The air suction and discharge device (14) is adjusted or controlled according to at least the surface and the quantity of the sorted objects (2), and the possibility of air passing through the discharge outlets (12).

The invention relates to the field of machines or installations for sorting objects or products, in particular objects or products at least part of which is recyclable, the sorting typically taking place on the basis of the material. In this context, the subject of the invention is an installation or machine for sorting objects with an aeraulic control device.

More particularly, the invention is directed to sorting installations or machines with planar geometry, preferably of the optical type, equipped with compressed air ejection systems (bar with pneumatic nozzles supplied by solenoid valves) installed at the end of a fast-moving conveyor (speed from 2 to 7 m/s), and controlled in relation to the classification results. One possible type of architecture of such a machine or installation is described, for example, in patent document EP1243350A1 of the applicant.

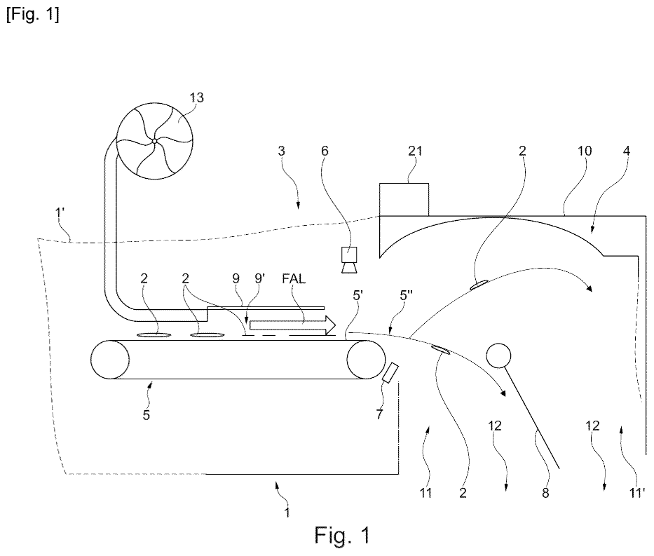

FIG. 1 schematically illustrates a known installation (1) for sorting objects (2) comprising, advantageously mounted in a casing (1′), a sorter (3) with planar geometry (sorting objects moving in a substantially monolayer manner on a plane), and an aeraulic management system (4) controlling the circulation of air in the installation (1).

The sorter (3), preferably of the optical type, comprises at least:
a conveyor (5) with a moving belt (5′) on which the objects (2) to be sorted are arranged in a single layer,
a detection device (6) configured to inspect the objects (2) circulating on the conveyor (5) and classify them after analysis into at least two categories,
an air jet ejection device (7) located at the outlet end (5″) of the conveyor (5) and configured to selectively eject upward the objects (2) detected as belonging to at least one of the classification categories and falling from said outlet end (5″),
at least one separation wall (8) arranged at a distance from the outlet end (5″) of the conveyor (5) and configured to separate at least one flow of freely falling objects (2) and one flow of ejected objects (2).

The aforementioned aeraulic management or control system (4) for its part comprises at least:
a containment structure (9) extending above the conveyor (5) over a longitudinal part of the latter and forming therewith a guide tunnel (9′) into which there is injected a laminar air flow (FAL) circulating substantially at the same speed as the objects (2) to be sorted,
an outlet box (10), forming part of, or mounted in, the casing (1′) as appropriate, cooperating with the separation wall(s) (8) to constitute a compartment (11) for receiving the non-ejected objects (2) and at least one compartment (11′) for receiving the ejected objects (2), these compartments (11, 11′) having outlets (12) for discharging the categorized objects (2) which have fallen therein.

This installation also comprises a command and control unit (21) for the various aforementioned functional components, in accordance with dedicated programming and prior calibration.

Such a sorting installation is marketed by the applicant under the designation “Mistral +Connect Full Package”, and the containment structure (9), associated with the air injection means and providing the tunnel, seat of the laminar flow accompanying the flow of moving objects, is known under the designation “Turbosorter” by the applicant. It comprises an optical sorter particularly well suited to sorting light products (plastic films, paper/cardboard), for fractions of 40 to 400 mm.

The aforementioned laminar air flow, which is substantially isokinetic with the sorting belt, prevents light objects placed on this belt from sliding between their detection (generally at the tunnel outlet) and their ejection at the end of the belt.

However, this additional laminar air flow (fal) also causes several drawbacks.

Thus, leaving the tunnel, the air flow undergoes decompression that can create turbulence in the detection zone. Now, if the flow became turbulent from this zone, it cannot become laminar (and therefore controlled and predictable) again in the ejection zone.

In addition, it may be difficult for the air flow emanating from the tunnel to be discharged from the outlet box or the machine casing, depending on the configuration of the discharge outlets in the lower zone and the environments into which they emerge (not shown in FIG. 1), these constituting the only trajectories for the release of excess air in the installation of FIG. 1. If these outlets or the downstream passages are too narrow or too crowded, or even become blocked, an overpressurized air cushion is created in the outlet box, and light objects tend to fly above this cushion. Their fall trajectory is then unpredictable, even if they have been ejected, which greatly harms the quality of sorting. Now, the design of the outlet zones for the sorted objects (downstream of the outlets) is generally not controlled by the manufacturer of the installation and there is therefore a risk that the aforementioned air cushion will form.

This risk is all the higher the higher the speed of the sorting belt, and therefore that of the laminar air flow. It is further aggravated when the ejection concerns a high percentage of the objects to be sorted, because the corresponding outlet, which also constitutes the main outlet for the excess air (because of its position at the bottom of the outlet box), is then heavily congested by these objects. However, it should be noted that the flow of compressed air from the blowing solenoid valves is generally still negligible compared with the FAL accompanying the objects, even with a high proportion of ejected objects. It therefore contributes very little to the formation of a harmful air cushion in the box.

Moreover, the presence of sharp edges or angles existing at different points on the trajectory of the air flow leaving the tunnel, in particular around the separation wall, is also a source of turbulence, associated with pressure drops.

Sorting installations, corresponding substantially to the aforementioned type, are already known in which an aeraulic control system with a closed air circuit is present, the air being recirculated between the ejection box and the sorting belt by a turbine. However, these known systems have a complex structure, are very energy intensive (high pressure drop) and not very adaptable, the air suction and the air injection being linked together.

The main object of the present invention is to overcome, at least in part, the main drawbacks of the known installations, in particular of the known installation mentioned in relation to FIG. 1 and mentioned above, by improving in particular the management of the air in such an installation, and more particularly in the output box.

This object is achieved for an installation described above by the fact that this installation is characterized in that the outlet box is subjected to air suction in order to discharge to the outside the excess air in the installation, substantially without disturbing the flows of the objects that are to be sorted or have been sorted, in that it comprises two mutually independent air circulation devices, for example with turbines, one of which ensures the injection of external air for the generation of the laminar air flow and the other of which ensures the suction and discharge to the outside of the installation of the excess air at the outlet box, and in that the air suction and discharge device is adjusted or controlled depending at least on the surface and quantity of the sorted objects, and on the possibilities of air passage at the discharge outlets.

Thus, the invention proposes to achieve positive and controlled suction of the excess air, independently of the injected air and taking into account the current situation in terms of spontaneous air discharge (especially through the outlets) and the type and quantity of objects to be sorted. Thanks to the invention, it is thus possible in particular to increase sorting performance (by improving the air circulation at the outlet box), while limiting energy consumption (by adapting the suction to the actual needs).

Specifically, the inventors have found that light and flat objects such as sheets of paper or plastic films have large surfaces almost perpendicular to the ejection axis. They therefore strongly disturb the free circulation of air in the compartment(s) of the ejected objects, where they cause overpressures and pressure drops. This harmful effect is substantially proportional to the quantity of objects that clutter this compartment at any time. By contrast, the surface of the non-ejected objects (i.e. not subjected to the air jets) is naturally aligned with the direction of their parabola of fall under the effect of gravity, which extends, beyond the end of the conveyor, the flat trajectory they had on the belt of the conveyor forming a sorting belt. This flow of non-blown objects is therefore little disturbed, and shows a high probability of remaining laminar and not creating overpressure. The overpressure in the vicinity of the compartment(s) for the ejected objects then tends to push the ejected objects back toward the compartment for the non-ejected objects, which degrades the quality of sorting. To compensate for this effect, the invention proposes means for directing the laminar air flow preferentially in the vicinity of the ejected objects.

In addition, it has also been found that, if the outlets are not sufficiently dimensioned and/or too congested to allow good discharge of the air, for example because of too high a density of sorted objects (in one or the other compartment), additional overpressures and turbulence occur, and make the trajectory of all objects even more random.

In all cases, the discharge to the outside of the excess air in the box, proposed by the invention, reduces these drawbacks, and more particularly in the vicinity of the ejected objects.

The invention will be better understood by virtue of the following description relating to preferred embodiments, which are given by way of non-limiting examples and are explained with reference to the appended schematic drawings, in which:

FIG. 1 is a schematic representation of the existing sorting installation, known to the applicant and mentioned above;

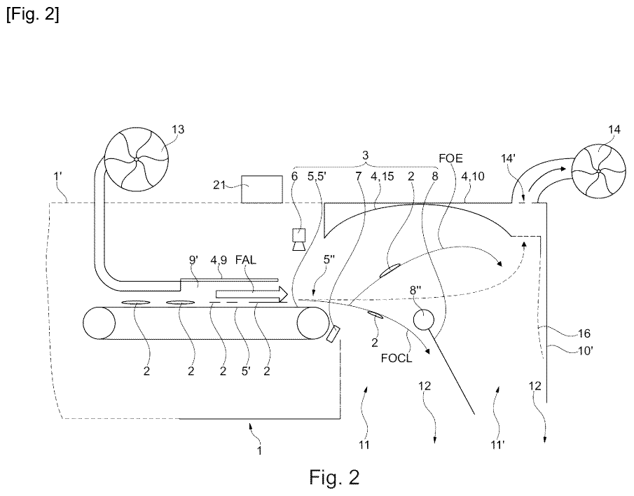

FIG. 2 is a schematic representation of an improved sorting installation according to a first embodiment of the invention;

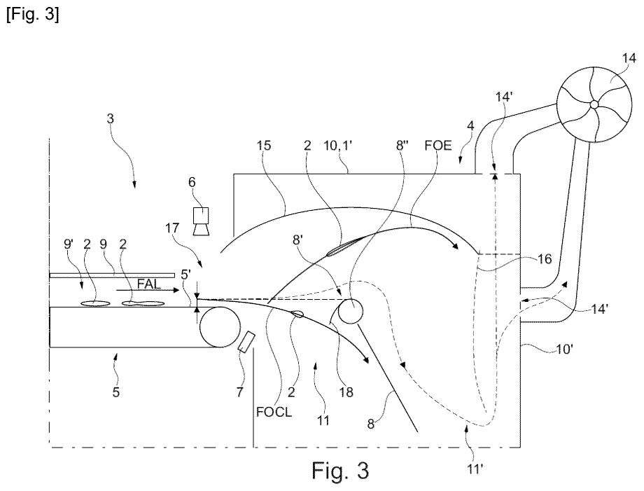

FIG. 3;

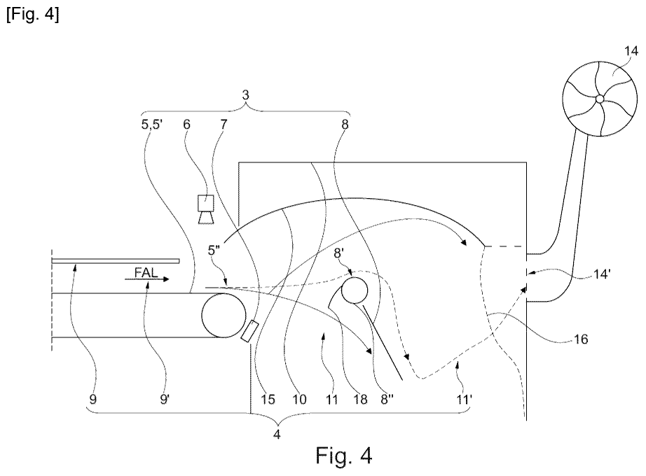

FIG. 4;

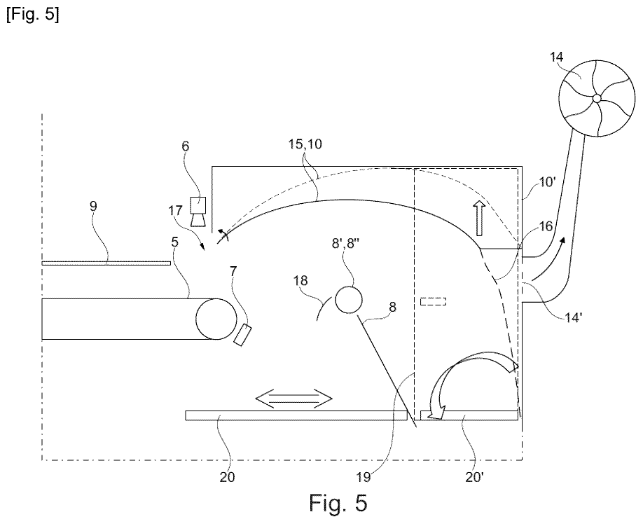

FIG. 5;

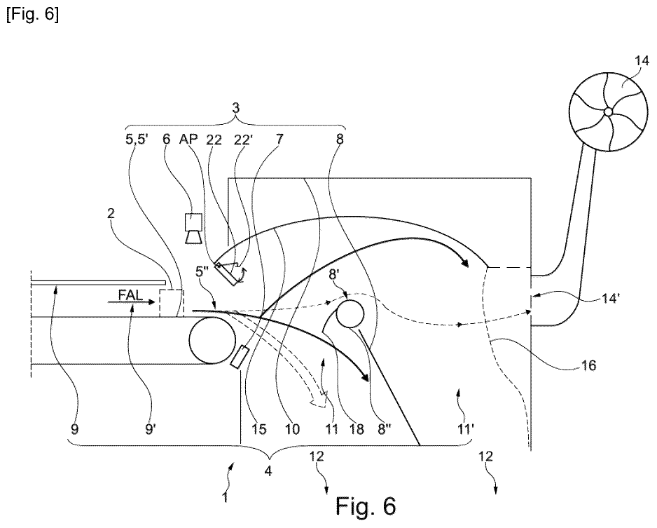

FIG. 6 and

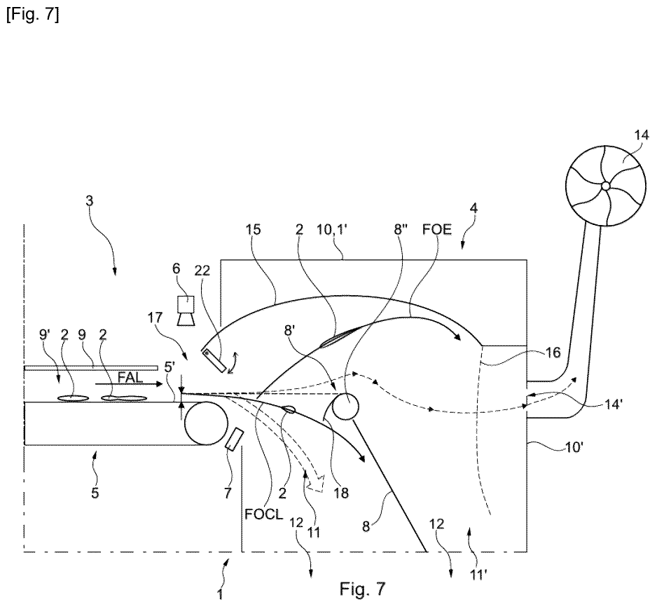

FIG. 7 are partial schematic representations of improved sorting installations in accordance with other embodiments of the invention (in FIGS. 2 to 7 the dashed arrows indicate the circulation of the majority component of the laminar air flow from the tunnel above the conveyor, with the air discharge flows through the outlets not being specifically represented).

FIG. 2, and partially FIGS. 3 to 7, illustrate an installation (1) for sorting objects (2) comprising, advantageously mounted in a casing (1′), a sorter (3) with planar geometry, and an aeraulic management system (4) controlling the circulation of air in the installation (1).

The sorter (3) comprises at least:
a conveyor (5) with a moving belt (5′) on which the objects (2) to be sorted are arranged in a single layer,
a detection device (6) configured to inspect the objects (2) circulating on the conveyor (5) and classify them after analysis into at least two categories,
an air jet ejection device (7) located at the outlet end (5″) of the conveyor (5) and configured to selectively eject upward the objects (2) detected as belonging to at least one of the classification categories and falling from said outlet end (5″), and
at least one separation wall (8) arranged at a distance from the outlet end (5″) of the conveyor (5) and configured to separate at least one flow (FOCL) of freely falling objects (2), on the one hand, and one flow (FOE) of ejected objects (2), on the other hand.

The aeraulic management system (4) for its part comprises at least:
a containment structure (9) extending above the conveyor (5) over a longitudinal part of the latter and forming therewith a guide tunnel (9′) into which there is injected a laminar air flow (FAL) circulating substantially at the same speed as the objects (2) to be sorted, and
an outlet box (10), forming part of, or mounted in, the casing (1′) as appropriate, cooperating with the separation wall(s) (8) to constitute a compartment (11) for receiving the non-ejected objects (2) and at least one compartment (11′) for receiving the ejected objects (2), these compartments (11, 11′) having respective outlets (12) for discharging the categorized objects (2) which have fallen therein.

According to the invention, the outlet box (10) is subjected to air suction in order to discharge to the outside the excess air in the installation (1), substantially without disturbing the flows of the objects (2) that are to be sorted or have been sorted. Furthermore, the installation (1) comprises two mutually independent air circulation devices (13, 14), for example with turbines, one (13) of which ensures the injection of external air for the generation of the laminar air flow (FAL) and the other (14) of which ensures the suction and discharge to the outside of the installation (1) of the excess air at the outlet box (10). The air suction and discharge device (14) is adjusted or controlled depending on at least the quantity of air injected by the device (13) and the possibilities of air passage at the discharge outlets (12).

Thanks to these provisions, the invention achieves the main object set and makes it possible in particular to reduce, or even eliminate, the possible negative impacts that may result from overpressures and/or turbulence, for example on the sorting performance (better reliability and repeatability of the results), and does so while limiting the energy expenditure in relation to the air circulation, with air suction totally independent (structurally, fluidically and functionally) of air injection. Moreover, by making the air suction and discharge adjustable according to variable needs and circumstances, it is in particular possible to guarantee an optimal aeraulic environment for sorting for variable running speeds, for example 3 m/s, 4.5 m/s or even 6 m/s. In terms of dimensioning and performance (flow rate) of the device (14) providing suction with discharge, it may advantageously be provided that these parameters are substantially equivalent to those of the external air injection device (13) for generating the laminar air flow (FAL). The sizes of the channels/ducts and the powers of the turbines (or analogous active suction members) of these two devices may thus be similar.

Although the suction device (14) is essentially described and represented herein in relation to an active air circulation means (turbine or the like), it may alternatively be envisioned that the suction of air toward the outside is carried out passively, for example by venting via a discharge structure generating a natural suction phenomenon, or by a simple pressure difference.

In accordance with an advantageous feature of the invention, which is also beneficial for the aeraulics in the zone of ejection and physical sorting of the objects, and as shown in FIGS. 2 to 5, the installation (1), and more specifically its aeraulic management and control system (4), comprises, at the outlet box (10), an upper deflecting wall (15) extending at least above the openings of the compartments (11, 11′), and a strip curtain (16) fastened at the top to said upper deflecting wall (15) and extending along a rear wall (10′) of the outlet box (10) or of the compartment (11′) receiving the ejected objects (2), opposite the corresponding separation wall (8).

Furthermore, the outlet box (10) comprises one or more air outlet openings (14′) fluidically connected to the air suction and discharge device (14) and located behind the upper deflecting wall (15) and/or behind the strip curtain (16). The wall (15) may be perforated or apertured at its end proximal to the rear wall (10′) of the box (10) and adjoining the curtain (16). At least one opening (14′) is present in the rear wall (10′)—FIGS. 4 and 5—or in the upper wall—FIG. 2—of said outlet box (10). In a variant, at least one opening (14′) may be provided both in the rear wall and in the upper wall (FIG. 3), being possibly selectively closable.

According to a design feature improving the guidance of the air flow leaving the tunnel (9′) and limiting its turbulent dispersion between the outlet of the latter and the rear wall of the box (10), the deflecting wall (15), of concave curved shape, extends to above the outlet end (5″) of the conveyor (5) and in the extension of the containment structure (9), being separated from the latter by an inspection window (17) for the detection device (6). This feature is readily identifiable in the appended drawings by comparing FIGS. 3 and 4 with FIG. 2. The aforementioned effect can be further increased by extending the or each separation wall (8) upward in such a way that its upper edge is located above the conveying plane of the conveyor (5) (plane on which the moving objects rest). The improvement of the aeraulics in the box (10) can be further improved when at least one deflecting or diverting wing (22) as described below is present.

As shown in FIGS. 3 to 5 (in particular by comparison with FIG. 2), the strip curtain (16), forming a flap, is arranged at a distance from the rear wall of the outlet box (10) or the compartment (11′) receiving the ejected objects (2), at least at the top, so as to be located above and partially in the compartment (11′) for receiving the ejected objects (2), and thus to interfere with the trajectory of the majority of the ejected objects (2). By advancing the strips (16) and moving them closer to the separation wall (8), they are moved into the trajectory of a larger number of ejected objects (2)—not only of those projected to the rear wall of the box. Thus, the vast majority of them hit these strips and have their horizontal speed canceled and their trajectory interrupted. Owing to their flexibility, the strips (16) stop the horizontal movement by absorbing their kinetic energy. Owing to this soft absorption, the objects (2), after coming into contact with these strips (16), slide downwards along them and do not tend to reverse. Thus, ejection into the correct outlet (12) is better ensured.

Furthermore, by moving them away from the back of the box (10), the strips have less tendency to be sucked in close to the opening (14′) in the rear wall of the box (10) when suction is performed at least partially at this level.

According to two possible design variants, the strips (16) can either be freely hanging (FIGS. 2, 3 and 5) or be secured at their lower ends to the rear wall (10′) of the outlet box (10) or of the compartment (11′) receiving the ejected objects (2) (FIG. 4).

In the first case (FIGS. 2, 3, 5 and 7), the strips (16), together forming a flap, are long enough to form a barrier between the suction opening (14′) of the rear or upper wall of the box to prevent the ejected light objects from being sucked in at this level. Moreover, their distance from said rear wall (10′) may be such that the suction generated tends to cause most of the air present in the box (10) to pass around the strips (16) from below (cf. dashed arrow in FIG. 3). A stream of air is thus created in the compartment (11′), especially when the strips are tightened together and are located at an adequate distance from the rear wall, driving the ejected objects (2) toward the corresponding outlet. In practice, and in a preferred manner, these strips (16) are located sufficiently far from this wall so that the speed of the air rising toward the suction opening is low (the majority of the air directed toward the opening 14′ passing through the apertured flap formed by the strips 16) and does not allow entrainment of the light objects, but also sufficiently close to it not to reduce too much the free cross section of the compartment for ejected objects.

When suction is carried out only through the upper wall of the box (FIG. 2), bypassing of the strips by the air flow does not need to be taken into account.

In the second case (FIGS. 4 and 6), the strips (16), which are secured at their lower ends to the rear wall of the outlet box (10) or the compartment (11′) receiving the ejected objects (2), are spaced apart from one another and form a curtain apertured with passages in the form of slots, and this apertured curtain is arranged in the outlet box (10) so as to be traversed by the internal air sucked in by the device (14) ensuring suction and discharge of said excess air.

The strip curtain (16), which forms an apertured flap to allow air to pass through and is fixed at its bottom, thus forms a puffy curtain overhanging in the compartment (11′). The objects (2) come into contact with it (and therefore cannot cling to it because of the puffy shape), lose their kinetic energy and fall by gravity into the appropriate outlet (FIG. 4).

It should be noted that in all the embodiments and embodiment variants described and shown, the air is sucked in above the compartment (11′) receiving the ejected objects (2), and preferably outside the trajectories of the latter.

In accordance with a preferred embodiment of the invention, and as shown in FIGS. 2 to 5, the sorter (3) of the installation is a binary-type sorter (3) and the outlet box (10) of the installation (1) comprises a single separation wall (8) dividing between them a first compartment (11) for receiving the non-ejected objects (2) and a second compartment (11′) for receiving the ejected objects (2).

Preferably, the separation wall (8) comprises, at and along its upper edge (8′), advantageously provided with a motorized roller (8″) forming a separator and preferably located above the plane of the conveyor (5), a wing (18) inclined toward the first compartment (11) and arranged to divert over said upper edge (8′) a portion of the laminar air flow (FAL) leaving the guide tunnel (9′).

As shown in FIGS. 3 and 4, in particular in comparison with FIG. 2, the air flow leaving the tunnel (9′) is first diverted upward by the wing (18) and, after passing the upper edge (8′), is directed into the compartment (11′) in relative vacuum, along the wall (8). This trajectory of the air ensures a better targeted ejection of the light objects and therefore their routing to the appropriate compartment (11′). Specifically, they have less tendency to flutter around and fall randomly on one side or the other of the separation wall (8).

In order to still further improve the aeraulics, and to reduce the possible overpressures and/or turbulence at the outlet box (10), while limiting energy expenditure, in particular by making it possible to reduce the activity of the air circulation device (14) which ensures suction and discharge to the outside, the installation (1) may comprise, as shown in FIGS. 6 and 7, at least one diverting wing (22) arranged and configured to direct the laminar air flow (FAL) leaving the guide tunnel (9′) at least partially, preferably at least half of it, toward the outlet (12) associated with the compartment (11) for receiving the non-ejected objects (2) (FOCL flow).

This wing (22) thus makes it possible, in the presence of an injected laminar air flow, to limit the possible negative impacts that may result from overpressures and/or turbulence, for example on the sorting performance (better reliability and repeatability of the results), while limiting energy expenditure.

The outlet box (10) is further provided, at least in the lower and/or rear part, and in particular at the outlets (12) and/or the rear wall (1′) of said box (10) located opposite from the outlet (5″) of the conveyor (5), with one or more openings (14′) for discharging air at atmospheric pressure, sufficient to limit or substantially prevent overpressure in said box (10) and the formation of air cushions in the outlets (12). For satisfactory operation of the installation over time, the configuration, dimensioning and arrangement of these openings, in particular the opening(s) (13) at the first outlet (12) and possibly the opening(s) (14′) in the rear part of the box, shall be designed so that these openings are not obstructed or slightly obstructed during operation by the sorted objects exiting through said outlets. If necessary, disengagement means, advantageously with automatic operation, may be provided for this purpose (scraper, blower, etc.).

Specifically, by diverting the major portion of the air flow (FAL) leaving the guide tunnel (9′) toward the first outlet (12) in the direction of the flow, which obviously has one or more openings (13) toward the outside of sufficient and clear cross section, the wing (22) makes it possible to i) suppress the propagation of this flow further forward into the outlet box (10), where it is liable to create turbulence (for example by rebound on walls), ii) to avoid the formation of an overpressure in the box, and to eliminate the cushion effects which may result therefrom, and iii) to limit or avoid jamming at the separation wall(s) (8), by limiting the quantity of objects landing on its upper edge (8′) while not disturbing the positive action of said flow (FAL) at the conveyor. In particular, it is possible to guarantee an optimized aeraulic environment for sorting for variable running speeds, for example 3 m/s, 4.5 m/s or 6 m/s.

The diverting wing (22), which is shown only schematically in the figures, is defined more precisely below by way of a favorable, non-limiting construction.

According to a very constructively favorable embodiment, it can be provided that the diverting wing (22) is located after the outlet of the tunnel (9′) for guiding the laminar air flow (FAL), preferably in the extension of and at a distance from the upper wall of the containment structure (9) in the direction of the laminar air flow (FAL), and extends transversely to this direction, so as to be impacted by an upper fraction of said flow (FAL), after its ejection out of said tunnel (9′). Thus, it influences the direction of propagation of said laminar flow in the box by bending it downward, but without forming an obstacle likely to block its propagation.

Advantageously, the diverting wing (22) is arranged between the outlet end (5″) of the conveyor (5) and a front edge of the upper deflecting wall (15), at a distance from the outlet of the guide tunnel (9′). Thus, the inspection window of the detection device (6) is not affected by the presence of this wing.

Preferably, the diverting wing (22) is mounted substantially at the inlet of the outlet box (10) and has a configuration, dimensioning and arrangement (in particular position and inclination) such that the upper fraction of the laminar air flow (FAL) which impacts it represents between about 15% and 35%, preferably between 20% and 30%, by volume of said air flow (FAL), and that the portion of said air flow (FAL) diverted toward the outlet (12) associated with the compartment (11) for receiving the non-ejected objects (2) (FOCL flow), or first outlet, flows substantially along the separation wall (8). This downward flow direction of this diverted fraction, obtained after passing the wing (18), can in particular be achieved by an appropriate inclination of the deflecting wing (22).

Thus, by positioning the diverting wing (22) in such a way that it interferes only with a limited upper zone of the extension of the passage of the tunnel (9′), it acts only on an upper fraction of the air flow (FAL) leaving the guide tunnel (9′), sufficient to divert it effectively at least in part, preferably at least half of it, into the first compartment/outlet, but without, however, constituting a disturbing obstacle for said flow, or even a cause of turbulence creation (disturbance of the laminar flow).

Preferably, the diverting wing (22) is configured and positioned in such a way that substantially a majority portion of the laminar air flow (FAL) leaving the tunnel (9′) is positively directed toward the first outlet (12), associated with the negative outlet (without ejection) adjoining the outlet of the conveyor (5). As a result, the air cushion effects will be suppressed at the other outlet(s) and the flow(s) of ejected objects (FOE) is (are) no longer disturbed, and follow(s) a solely ballistic trajectory.

As shown in FIG. 6 and according to a favorable design feature, making it possible to avoid a possible malfunction due to a blockage of an object (2) of great height at the diverting wing (22), the latter can be mounted with the capability of retracting upward, preferably by positive lifting, under the action of a moving object (2) coming into contact with it during its passage under said wing (22).

In accordance with a preferred variant, illustrated schematically in FIG. 6, the diverting wing (22) is mounted so as to pivot about an axis (AP) arranged in a plane parallel to the conveying plane and arranged perpendicularly to the direction of movement of the objects (2), said axis (AP) being located at a distance from the plane of the conveyor (5) at least equal to the height of tunnel (9′) and advantageously extending along one of the longitudinal edges of diverting wing (22).

This wing (22) can thus pivot between a lower position in which it fulfills its function of diverting at least part of the laminar flow toward the first outlet, and a more or less raised position according to the size of the object (2) of great height which lifts it while passing under it. The permitted lifting is at least sufficient for the wing (14) to be able to be arranged entirely in the plane parallel to the plane of the conveyor and comprising the axis (AP). Stops are advantageously provided to define the end pivoting positions, respectively a lower position (current functional position in the absence of the presence of an interfering object) and an upper position (only an upper stop 22′ is shown in FIG. 6). The return to the lower position of the wing (22) can result from the action of gravity alone, or possibly be the result of the combined action of gravity and a return means, for example an elastic return means.

In accordance with one possible feature of the invention, the wing (22) may, depending on the intended sorting applications, be adjusted on site in a vertical position and angularly in order to precisely regulate and direct the laminar flow in the box (10) and thus control its effects and adapt it to the different configurations and variants of the installation (type of object to be sorted, binary sorting, ternary sorting). Said wing (22) is preferably rectangular in shape (elongate strip), flat and extends transversely over the entire width of the conveyor belt (5′).

The configuration and arrangement of this wing (22)—length, width, profile/shape, inclination about the axis (AP), positioning in terms of height-are advantageously adapted to the type and size of the installation (1), to the application on site and to the desired aeraulic effects, while possibly being at least partially adjustable. They can also be determined so as to create a negative pressure effect in the outlet or each of the outlets for the ejected objects.

The combination of the aforementioned wall (15) and wing (22) makes it possible to reduce the turbulent dispersion of the air flow leaving the tunnel at the window (17) and in the outlet box (10) and to guide the majority component of this flow toward the nearest outlet to the outlet of the conveyor and the minority component to the most distant outlet(s). It may of course be envisioned to be able to move this wall (15) and/or this wing (22), in rotation and/or in translation, in order to modify their position and/or inclination, and thus to be able to modify in a controllable manner the circulations of the air flows in the box, and for example to adapt the aeraulic configurations prevailing in the latter to the types of products to be sorted, to the remaining turbulence and/or to the circumstances of discharging air to the outside.

As shown in FIGS. 4 to 7, and in particular in the presence of at least one deflecting wing (22), it can advantageously be provided that the outlet box (10) comprises only one or more air outlet openings (14′) located behind the strip curtain (16) and present in the rear wall (10′) of said box (10). The result is a simpler and more favorable construction in terms of aeraulics and sorting performance.

In accordance with another advantageous feature of the invention, which emerges from FIG. 5, that is compatible with the aforementioned features and variants and is beneficial in relation to maintenance at the outlet box (10), the upper deflecting wall (15) constitutes the upper closure wall or roof of the outlet box (10) and is mounted so as to be movable, translationally or pivotably, between a lowered working position and a raised maintenance position (cf. the arrow illustrating the pivoting movement of this wall at its front end).

Moreover, the volume of the outlet box (10) has, in the raised position of the deflecting wall (15), a clear space sufficient to allow access of an operator, preferably in a standing position, into the compartment (11′) for receiving the ejected objects (2), for example, through a door (19) mounted in a side wall of said box (10).

Furthermore, and as also shown in FIG. 5, at least one of the compartments (11, 11′), among the compartment (11) for receiving the non-ejected objects (2) and the compartment (11′) for receiving the ejected objects (2), is preferably equipped with a respective platform (20, 20′) for an operator, this or these platform(s) (20, 20′) being mounted so as to be movable between a retracted position of non-use and a deployed position of use, the movement from one position to the other being effected by sliding or tilting.

As illustrated in FIG. 5, a first platform (20) can be mounted so as to be able to move in translation between a stowed position under the conveyor (5) and a deployed position in the compartment (11) for receiving the non-ejected objects. A second platform (20′) can for its part be mounted with the ability to pivot on the rear wall (10′) of the outlet box (10) and can thus be moved between a raised stowed position (against said wall) and a lowered position in which it extends into the compartment (11′) for receiving the ejected objects (see the arrows in FIG. 5).

In order to change the configuration of the installation (between work and maintenance) in a secure manner, it may comprise a controlled actuator, for example a hydraulic or electric ram, ensuring the controlled movement of the upper deflecting wall (15) between its lowered working position and its raised maintenance position, this actuator (not shown) also ensuring simultaneous and synchronous movement at least of the platform (20′) associated with the compartment (11′) for receiving the ejected objects (2), between its retracted position and its deployed position (cf. the arrows indicating the translational and rotational movements in FIG. 5).

Herein, the invention is shown in the appended figures and essentially described in relation to a binary sorting installation, that is to say with an outlet for the ejected objects (subjected to the action of an air jet) and an outlet for the non-ejected objects (not subjected to the action of an air jet and which fall freely when leaving the conveyor). However, a person skilled in the art can easily use his general knowledge to transpose the improvements of the invention to a ternary sorting installation, that is to say with two ejected outlets by adapting the air jet ejection device (7) (implementation of two different types of jets) and the outlet box (10) (presence of two separation walls and three receiving compartments, namely an additional receiving compartment for ejected objects, located between the two receiving compartments described and shown).

Of course, the invention is not limited to the embodiments described and shown in the appended drawings. Modifications remain possible, in particular in terms of the constitution of the various elements or by substitution of technical equivalents, without thereby departing from the scope of protection of the invention.

1. An installation for sorting objects comprising:
mounted in a casing, a sorter with planar geometry, and
an aeraulic management system controlling the circulation of air in the installation,
the sorter has at least:
a conveyor with a moving belt on which the objects to be sorted are arranged in a single layer,
a detection device configured to inspect the objects circulating on the conveyor and classify them after analysis into at least two categories,
an air jet ejection device located at the outlet end of the conveyor and configured to selectively eject upward the objects detected as belonging to at least one of the classification categories and falling from said outlet end,
at least one separation wall arranged at a distance from the outlet end of the conveyor and configured to separate at least one flow of freely falling objects and one flow of ejected objects, and
the aeraulic management system comprising at least:
a containment structure extending above the conveyor over a longitudinal part of the latter and forming therewith a guide tunnel into which there is injected a laminar air flow (FAL) circulating substantially at the same speed as the objects to be sorted,
an outlet box, forming part of, or mounted in, the casing as appropriate, cooperating with the separation wall(s) to constitute a compartment for receiving the non-ejected objects and at least one compartment for receiving the ejected objects, these compartments having respective outlets for discharging the categorized objects which have fallen therein, wherein the outlet box is subjected to air suction in order to discharge to the outside the excess air in the installation, substantially without disturbing the flows of the objects that are to be sorted or have been sorted, in that it comprises two mutually independent air circulation devices for example with turbines, one of which ensures the injection of external air for the generation of the laminar air flow and the other of which ensures the suction and discharge to the outside of the installation of the excess air at the outlet box, and in that the air suction and discharge device is adjusted or controlled depending at least on the surface and quantity of the sorted objects, and on the possibilities of air passage at the discharge outlets.

2. The installation for sorting objects as claimed in claim 1, wherein the installation comprises, at the outlet box, an upper deflecting wall extending at least above the openings of the compartments and a strip curtain fastened at the top to said upper deflecting wall and extending along a rear wall of the outlet box or the compartment receiving the ejected objects, opposite the corresponding separation wall, the outlet box comprising one or more air outlet openings fluidically connected to the air suction and discharge device and located behind the upper deflecting wall and/or behind the strip curtain.

3. The installation for sorting objects as claimed in claim 2, wherein the deflecting wall, of concave curved shape, extends to above the outlet end of the conveyor and in the extension of the containment structure, separated from the latter by an inspection window for the detection device.

4. The installation for sorting objects as claimed in claim 2, wherein the strip curtain is arranged at a distance from the rear wall of the outlet box or the compartment receiving the ejected objects, at least at the top, so as to be located above and partially in the compartment for receiving the corresponding ejected objects, and thus to interfere with the trajectory of the majority of the ejected objects, the strips being either freely hanging or secured at their lower ends to the rear wall of the outlet box or the compartment receiving the ejected objects.

5. The installation for sorting objects as claimed in claim wherein the strips, secured at their lower ends to the rear wall of the outlet box or the compartment receiving the ejected objects, are spaced apart and form a curtain perforated by slotted passages, and in that this perforated curtain is arranged in the outlet box so as to be traversed by the excess air sucked in by the device ensuring the suction and discharge of said excess air.

6. The installation for sorting objects as claimed in claim 1, wherein said installation comprises a binary-type sorter and a single separation wall dividing between them a first compartment for receiving the non-ejected objects and a second compartment for receiving the ejected objects, this separation wall comprising, at and along its upper edge, provided with a motorized roller forming a separator and situated above the plane of the conveyor, a wing inclined toward the first compartment and arranged to divert over said upper edge a portion of the laminar air flow leaving the guide tunnel.

7. The installation for sorting objects as claimed in claim 2, the upper deflecting wall constitutes the upper closure wall or roof of the outlet box and is mounted so as to be movable, translationally or pivotably, between a lowered working position and a raised maintenance position, the volume of the outlet box having, in the raised position of the deflecting wall, a clear space sufficient to allow access by an operator, into the compartment for receiving the ejected objects, for example through a door mounted in a lateral wall of said box.

8. The installation for sorting objects as claimed in claim 2, wherein at least one of the compartments among the compartment for receiving the non-ejected objects and the compartment for receiving the ejected objects, is equipped with a respective platform for an operator, this or these platform(s) being mounted so as to be movable between a retracted non-use position and a deployed use position, the movement from one position to the other being effected by sliding or tilting.

9. The installation for sorting objects as claimed in claim 7, wherein said installation comprises a controlled actuator, for example a hydraulic or electric ram, ensuring the controlled movement of the upper deflecting wall between its lowered working position and its raised maintenance position, this actuator also ensuring a simultaneous and synchronous movement at least of the platform associated with the compartment for receiving the ejected objects, between its retracted position and its deployed position.

10. The installation for sorting objects as claimed in claim 1, wherein said installation further comprises at least one diverting wing arranged and configured to direct the laminar air flow (FAL) leaving the guide tunnel at least partially, toward the outlet (12) associated with the compartment for receiving the non-ejected objects.

11. The installation for sorting objects as claimed in claim 10, wherein the diverting wing is located after the exit of the tunnel for guiding the laminar air flow in the extension of and at a distance from the upper wall of the containment structure in the direction of the laminar air flow and extends transversely to this direction, so as to be impacted by an upper fraction of said flow after its ejection out of said tunnel.

12. The installation for sorting objects as claimed in claim 10, wherein the diverting wing is mounted substantially at the inlet of the outlet box and has a configuration, a dimensioning and an arrangement such that the upper fraction of the laminar air flow impacting it represents approximately between 15% and 35%, preferably between 20% and 30%, by volume of said air flow ejected from the tunnel, and such that the portion of said air flow diverted toward the outlet associated with the compartment for receiving the non-ejected objects, or first outlet, flows substantially along the separation wall.

13. The installation for sorting objects as claimed in claim 10, wherein the diverting wing is mounted so as to be able to be retracted upward, preferably by positive lifting, under the action of an object moving along and coming into contact with it during its passage below said wing.

14. The installation for sorting objects as claimed in claim 4, wherein the diverting wing is mounted so as to be pivotable about an axis arranged in a plane parallel to the plane of the conveyor and arranged perpendicularly to the direction of movement of the objects, said axis being located at a distance from the plane of conveyor at least equal to the height of the tunnel and extending along one of the longitudinal edges of the diverting wing.

15. The installation for sorting objects as claimed in claim 1, wherein the outlet box comprises only one or more air outlet openings located behind the strip curtain and present in the rear wall of said box.
